(19) United States
(12) Patent Application Publication
(10) Pub. No.: US 2005/0001787 A1
(43) Pub. Date: Jan. 6, 2005

(54) Multiple view display

(76) Inventors: David James Montgomery, Oxford (GB); Diana Ulrich Kean, Oxfordshire (GB)

Correspondence Address: MARK D. SARALINO (GENERAL);RENNER, OTTO, BOISELLE & SKLAR, LLP, 1621 EUCLID AVENUE, NINETEENTH FLOOR, CLEVELAND, OH, 44115-2191, US

(21) Appl. No.: 10/875,870

(22) Filed: Jun. 24, 2004

(30) Foreign Application Priority Data
Jun. 28, 2003 (GB) 0315171.9

(51) Int. Cl. G09G 5/00

(52) U.S. Cl. 345/6

(57) ABSTRACT

A multiple view display comprises a display device such as an LCD and a parallax generating device such as a parallax barrier. The LCD and the barrier cooperate to form viewing regions for viewing a stereoscopic pair of views or for different viewers to see unrelated views from the same display. The display device comprises composite pixel groups, each of which comprises red, green and blue pixels with at least two pixels of the same colour and receiving the same image data. The pixels of the same colour may be connected together to receive the same image data or may be supplied with the same image data by a controller.

This Nonprovisional application claims priority under 35 U.S.C. § 119(a) on Patent Application No. 0315171.9 filed in Great Britain on 28 Jun. 2003, the entire contents of which are hereby incorporated by reference.

### TECHNICAL FIELD

The invention relates to multiple view displays. Such displays may be used to display stereoscopically related images in viewing regions so as to form a three-dimensional (3D) autostereoscopic display. Such displays may also be used to display two or more unrelated views to different viewers. Such displays have applications, for example, in consumer and professional photography, 3D television, police identification, medical imaging, scientific visualisation, 3D advertising, 3D displays, dual view applications, interactive entertainment, vehicle displays and displays for passengers in aircraft.

### BACKGROUND

A known type of autostereoscopic 3D display is disclosed in EP 0 833 184 and EP 0 625 861 and an example of a display of this type is illustrated in FIG. 1 of the accompanying drawings. The display comprises a spatial light modulator 1 embodied by a liquid crystal device and a parallax optic 2 in the form of a lenticular screen comprising an array of cylindrically converging lenses such as 3. The device 1 comprises a black mask 5 defining a two-dimensional array of pixels (picture elements) such as 4. The pixels are arranged as rows and columns and each lenticule 3 cooperates with three columns of pixels displaying views 1, 2, and 3 in a three-view embodiment to define viewing regions in which the respective images are visible. The black mask 5 is such that there are no continuous vertical strips of the black mask between adjacent pairs of columns of the pixels 4. Such an arrangement reduces Moiré fringing and thus improves viewing quality. Arrangements of red, green and blue pixels are described for improving colour resolution and for reducing overlap in viewing windows and Moiré patterning.

U.S. Pat. No. 5,850,269 discloses a display in which the pixels are arranged in a generally horizontal fashion and cooperate with a lenticular screen. This arrangement is intended to improve the colour performance of the viewing windows of the display.

U.S. Pat. No. 4,600,274 discloses a 2D display in which pixels comprising three complementary colours are arranged as a square array with one colour repeated. Individual pixels of the same colour in each group are refreshed independently of each other and receive different image data.

JP 2 000 078 617 discloses a 3D display in which the signal and drain lines of an addressing matrix of a liquid crystal device are arranged so as to improve 3D display quality. This involves reducing the horizontal width of the pixels to allow for increased electronics between the pixels and so that the vertical height of the pixels may be increased. Such an arrangement provides reduced crosstalk between views.

JP 7-28015 discloses a 3D display in which the relative positions of the pixels and their spacing and orientation provides reduced crosstalk between views.

EP0752610 discloses the use of colour pixel “tessellations” for reducing undesirable visual artefacts, particularly colour separation. The embodiments shown in FIGS. 13 to 22 of this document have composite pixel groups comprising RGGB individual colour pixels. Each composite pixel group receives data from two image pixels and the way these data are combined is described in the passage beginning at column 10 line 43 of this document. In particular, the red and blue components from two consecutive pixels of each image are summed and supplied to the red and blue pixels of the composite group. On the other hand, the green data for the consecutive pixels are supplied individually to the two green pixels of the composite group. When the green components of the two consecutive pixels are different, the two green pixels of the composite group receive different data. The use of consecutive pixel green data is for the purpose of providing good image resolution.

### SUMMARY

According to the invention, there is provided a multiple view display for displaying N views where N is an integer greater than 1, comprising: a display device comprising a plurality of composite pixel groups, each of which comprises pixels of at least three different colours with at least two pixels of the same colour; a parallax generating device cooperating with the display device to define a plurality of viewing regions; and means for supplying the pixels of the same colour of each group with the same image data.

The at least three different colours may comprise three different colours. The three different colours may comprise red, green and blue.

The pixels may be arranged as sets of N columns with each set cooperating with a respective parallax element of the parallax device.

Each group may comprise four pixels with two of the same colour. The groups may be arranged as rows with the pixels of the same colour being the same colour in each row. The pixels of the same colour may be the same colour in all of the rows.

The pixels of each group may be arranged as two pairs of different coloured pixels in a pair of columns separated by (N−1) columns.

The pixels of the same colour may be of smaller area than the other pixels.

Each group of pixels may comprise a pair of triplets of red, green and blue pixels with the triplets in a pair of columns separated by (N−1) columns.

Each group of pixels may comprise a pair of triplets of red, green and blue pixels arranged in a row with adjacent pairs of the pixels of each group being separated by (N−1) columns.

The supplying means may comprise a controller for supplying image data to the display device.

The supplying means may comprise a respective permanent connection between pixels of the same colour of each group.

The supplying means may comprise a switching arrangement for switching between a multiple view mode of operation, in which pixels of the same colour of each group are connected together, and a one-view mode of operation, in which each pixel of the same colour of each group is connected to a pixel of the same colour of a different group in an adjacent column.

The areas of the pixels of each group may be such that each group is colour-balanced to white when the pixels are at maximum intensity.

The views may be stereoscopically related.

The views may be unrelated to each other.

N may be equal to 2.

The display device may be a liquid crystal device.

The parallax device may be a parallax barrier.

It is thus possible to provide a multiple view display in which the angular separation of different views may be made larger or smaller without requiring any change in the thickness of substrates within the display. For example, the angular separation of views may be increased without requiring the use of thin substrates, such as relatively thin glass, which would be difficult to handle during manufacture. In the case of 3D autostereoscopic displays, a closer viewing distance may be obtained whereas, for displays providing unrelated images to different viewers, the angular separation between the viewing regions can be increased.

In applications where greater viewing distances are required, this may also be achieved without requiring different substrate thicknesses.

In some embodiments, it is possible to reduce the colour pixel visibility of the display. In the case of displays of the front parallax barrier type, it is also possible in some embodiments to use high pitch pixels on low resolution display devices so that the barrier structure is less visible.

These improvements may be obtained with display devices such as liquid crystal devices, in which the spatial resolution and the display area size of the device are not changed in comparison with known arrangements.

### BRIEF DESCRIPTION OF THE DRAWINGS

FIG. 1 is a diagram illustrating a known type of 3D autostereoscopic display;

FIG. 2 is a diagrammatic cross-sectional plan view of a two-view display and illustrates a class of embodiments of the invention;

FIG. 3 is a diagram illustrating a known pattern of pixels forming a composite pixel group;

FIGS. 4 and 5 are diagrams illustrating patterns of pixels forming composite groups and constituting embodiments of the invention;

FIG. 6 is a diagram illustrating connections for a 3D-only example of the embodiment illustrated in FIG. 4;

FIG. 7 is a diagram similar to FIG. 6 illustrating an arrangement for switching between 2D and 3D modes of operation; and

FIGS. 8 to 10 are diagrams similar to FIG. 4 illustrating other pixel patterns of composite pixel groups constituting embodiments of the invention.

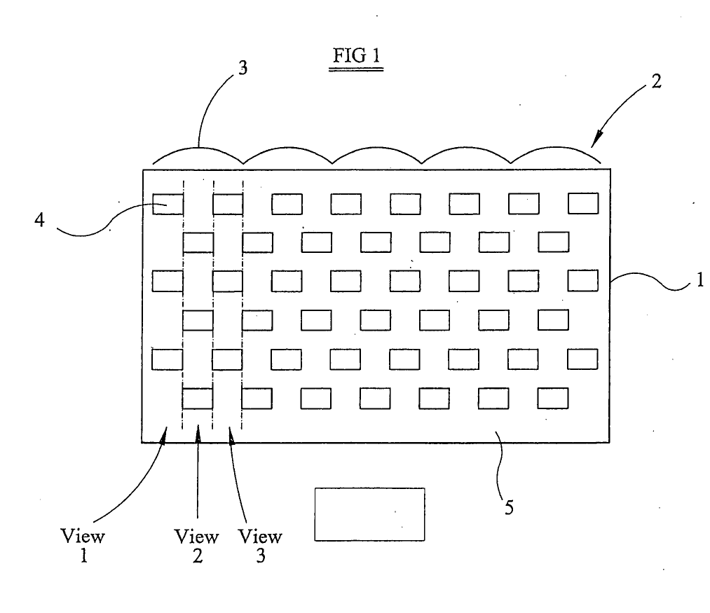

Like reference numerals refer to like parts throughout the drawings.

### DETAILED DESCRIPTION

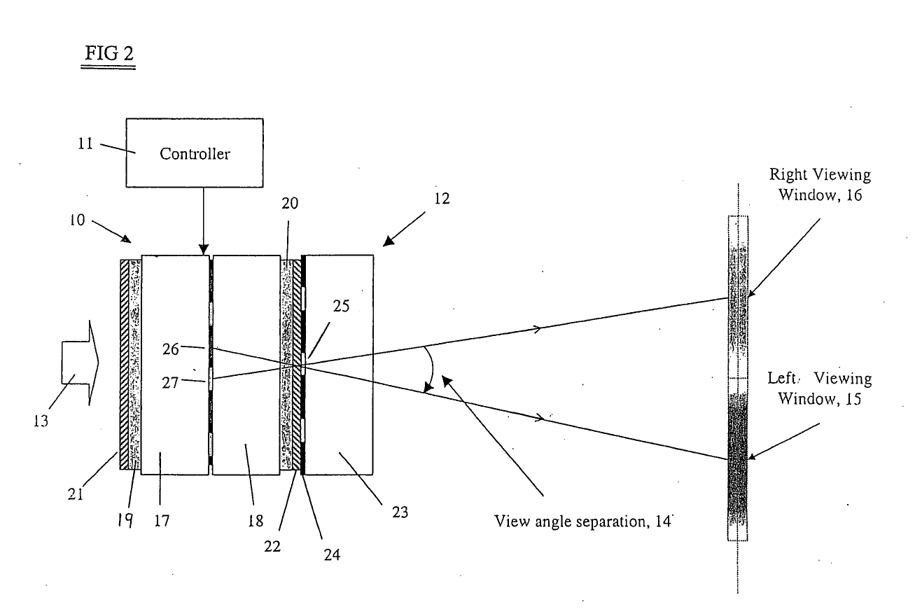

FIG. 2 illustrates a directional display of the front parallax barrier type for displaying two views, which may comprise a stereoscopic pair for displaying autostereoscopically a 3D image or which may be unrelated to each other for viewing by two viewers. The display comprises a spatial light modulator (SLM) in the form of a liquid crystal device (LCD) 10 receiving image data for display from a controller 11. The LCD 10 is disposed between a parallax barrier 12 and a backlight (not shown) supplying light illustrated diagrammatically at 13. The LCD 10 cooperates with the parallax barrier 12 to supply two views with an angular separation 14 in a left viewing window 15 and a right viewing window 16.

The LCD 10 comprises glass substrates 17 and 18 provided on their adjacent surfaces with addressing electrodes and alignment layers (not shown) separated by a layer of liquid crystal material. The electrode arrangement is such as to define an array of pixels and colour filtering (not shown) is provided between the substrates 17 and 18 so as to define red, green and blue colour pixels arranged as composite “white” groups as described hereinafter. The exterior surfaces of the substrates 17 and 18 carry polarisers 19 and 20 and viewing-angle films 21 and 22.

The parallax barrier 12 is formed on a further substrate 23 carrying a layer 24 which defines parallel evenly spaced vertical slits such as 25 separated by opaque regions. The horizontal pitch of the slits 25 is close to but less than the horizontal pitch of the pixels such as 26 and 27 so as to provide viewpoint correction such that all of the pixels, such as 26, displaying the left view across the LCD 10 are visible in the left viewing window 15 and all of the pixels, such as 27, across the LCD 10 displaying the right view are visible in the right viewing window 16. Viewpoint correction is known and will not be described further.

The controller 11 may comprise any suitable arrangement for supplying image data to the individual pixels. The controller may, for example, receive multiple view image data and may arrange this for supply to the LCD 10 in the appropriate order to ensure that all of the pixels display the correct pixel image data. The controller 11 may generate the image data or may process image data supplied from elsewhere. The image data may represent real images or artificial images, for example generated by a computer.

Although a parallax optic in the form of the parallax barrier 12 is illustrated in FIG. 2, other parallax generating devices may be used. For example, the parallax barrier 12 may be replaced by a lenticular screen and either may alternatively be disposed on the side of the LCD 10 adjacent the backlight. Although normal parallax elements are described hereinbefore, an optic having slanted elements may also be used. Further, in place of a parallax optic, the parallax generating device may comprise the backlight, for example in the form of a light source providing switchable light lines. Also, although an LCD 10 of the transmissive type is shown, a reflective type may be used or the SLM may be of the light-emissive type.

The pixels of the LCD 10 are arranged as composite white pixel groups such that the area of the composite group is balanced in colour to be white when the individual pixels are fully transmitting and only one colour data value is required for and supplied to the or each set of pixels of the group of the same colour.

Barrier visibility is the spatial resolution of the barrier slits as seen by one eye of an observer. Colour visibility is the spatial resolution as seen by one eye of the columns of the white composite pixel groups. It is desirable for barrier and colour visibilities to be low (by having relatively high spatial frequencies) in order to provide good quality image display.

For an autostereoscopic 3D display or a multiple (unrelated) view display of the type shown in FIG. 2 (and of other types as described hereinbefore), the view angle separation V is given in radians approximately by V=np/s, where n is the refractive index of the glass of the substrates, p is the pixel pitch of the LCD 10, and s is the separation between the plane containing the pixels 26, 27 and the effective plane 24 of the parallax barrier 12. For a 3D display, the optimum viewing distance R is given approximately by R=e/V, where e is the normal eye separation of a viewer.

For a 3D display, there is typically an “ideal” viewing distance and thus a corresponding ideal view angle separation. Resolution and size requirements generally restrict the choice of the pixel pitch p and the refractive index n of the glass substrates is not generally considered to be variable for practical reasons. Thus, in order to vary the view angle separation so as to achieve the ideal value, the separation s would have to be varied. If a relatively small viewing distance is required, then a relatively large view angle separation would be needed and this could only be achieved by using relatively thin glass for the substrate 18. However, such thin glass is difficult to handle during manufacture and is generally undesirable.

In the case of multiple view displays, such as dual view displays, displaying unrelated or independent images to two or more different viewers, it is generally desirable for the view angle separation to be substantially bigger than that required for 3D displays. Again, if this is achieved by using a relatively thin substrate 18, problems occur because of the need to handle relatively thin glass during manufacture.

In other cases, some large relatively thin displays, for example in lap top computers, may have limitations to the maximum glass thickness. In such cases, it may be difficult to achieve a sufficiently large viewing distance because of the constraint on maximum glass thickness.

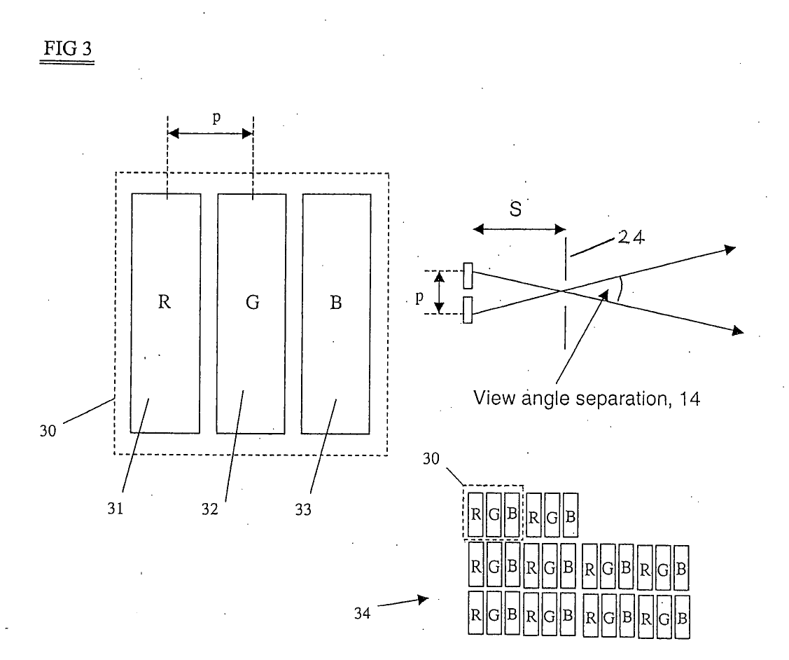

FIG. 3 illustrates a conventional composite white pixel group 30 comprising a red pixel 31, a green pixel 32 and a blue pixel 33. The composite pixel groups 30 are arranged as rows and columns as illustrated at 34. When used with a parallax generating device in a multiple view display, for example as shown in FIG. 2, the pixel pitch p determines the view angle separation 14 because of the constraints on substrate glass thickness as described hereinbefore.

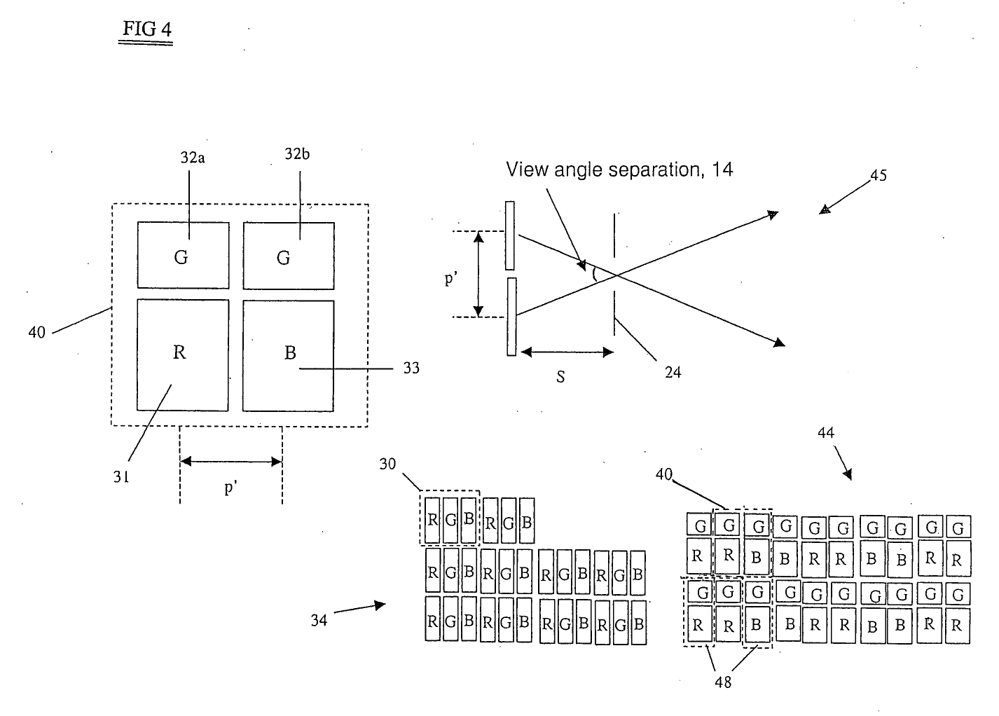

FIG. 4 illustrates a composite white pixel group 40 used in the display shown in FIG. 2 to form a first embodiment of the invention. The pixels of the group 40 comprise a first pixel of a first colour, a second pixel of a second colour, and two further pixels of a third colour. Without loss of generality, in this embodiment, the pixels of the group 40 comprise a red pixel 31, a blue pixel 33, and two green pixels 32a and 32b arranged in and occupying the same composite group shape and size as in the known arrangement shown in FIG. 3. The pixels 32a and 32b receive the same green image data so that the effective resolution of the LCD 10 is the same as for the pixel pattern shown in FIG. 3. The areas of the pixels 31, 32a, 32b and 33 are such that the composite group is balanced to white when all four pixels are fully transmitting.

The composite pixel groups are arranged in rows and columns as illustrated at 44, with the arrangement 34 of FIG. 3 repeated for comparison. The horizontal pixel pitch p′ of the composite group 40 is greater than the pitch p for the known arrangement of FIG. 3 by approximately 50% so that the view angle separation 14 as shown at 45 is greater. In the case of a 3D autostereoscopic display using the composite pixel groups 40 of FIG. 4, the viewing distance is therefore reduced. For a multiple unrelated view display, the view angle separation 14 between views is increased. This is achieved without requiring any change in the thickness of substrate glass and without changing the display resolution.

The composite groups 30 and 40 shown in FIGS. 3 and 4, respectively, are the effective groups for displaying a single view, such as a 2D view, with the parallax barrier 24 removed or disabled. However, the pixel groups 30 and 40 illustrate the increase in horizontal pixel pitch achieved by the use of the composite pixel pattern 40 shown in FIG. 4. When used in the multiple view mode of operation, which may be the only possible mode of the display, the pixels forming one composite group are illustrated at 48 in FIG. 4 for a two view display. Each slit of the parallax barrier is associated with two columns of the pixels and the pixels of the composite group 48 are in the same row but are spaced apart by one pixel column. In general, for an N view display, the pixels of each composite group are arranged in two columns separated by (N−1) columns and are in the same row.

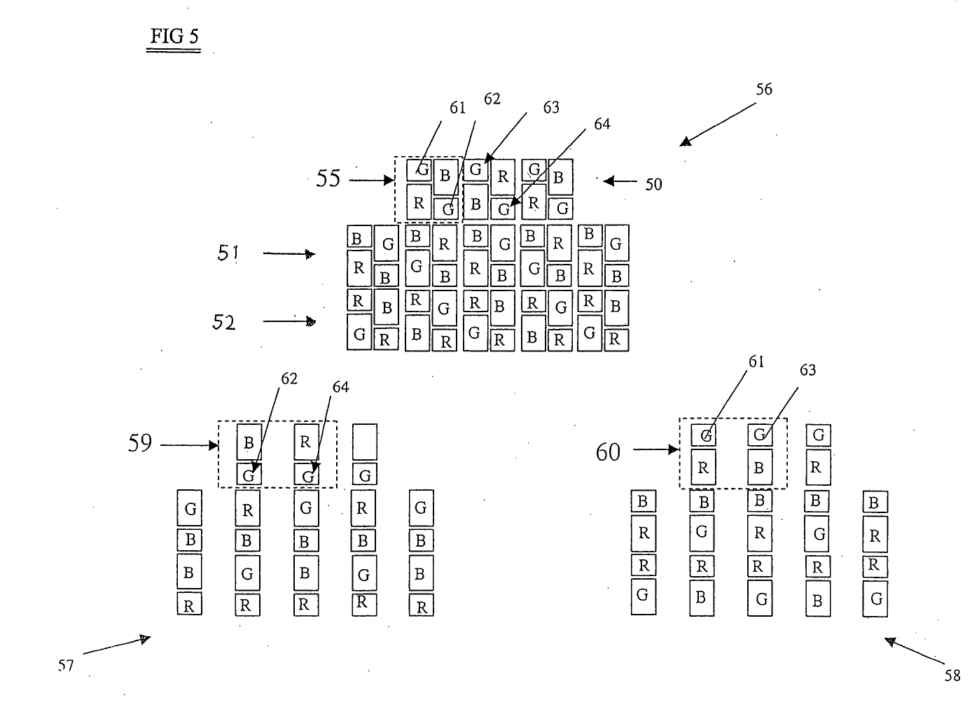

In FIG. 4, the composite pixel groups in all of the rows comprise a red pixel 31, two green pixels 32a and 32b, and a blue pixel 33. FIG. 5 illustrates an alternative pattern, which differs from the pattern shown in FIG. 4 in two ways. In FIG. 4, the green pixels 32a and 32b are all in the same relative position whereas, in FIG. 5, the positions of the smaller and larger pixels alternate vertically in each row. Secondly, whereas all of the “duplicated” pixels of the same colour in FIG. 4 are green, the colours of these pixels are different in different composite group rows so that the duplicated pixels of the same colour in the composite group row 50 are green, those in the row 51 are blue, and those in the row 52 are red. Thus, each composite group in the row 51 comprises two blue pixels together with a red pixel and a green pixel and each composite group in the row 52 comprises two red pixels with a green pixel and a blue pixel.

In the single view or 2D mode of operation as illustrated at 56 in FIG. 5, the pixels are arranged as composite groups such as 55. In this case, the same image data are supplied to the duplicated pixels of each composite group 55 such that the pixels 61 and 62 receive the same green image data for the composite group 55 and the green pixels 63 and 64 receive the same image data for their pixel group.

FIG. 5 illustrates at 57 and 58 the composite pixel groups for the left eye view and the right eye view, respectively, in the 3D autostereoscopic mode of operation; the same pixel groupings apply for dual unrelated image modes of operation for two different viewers. An example of a composite white pixel group for the left eye image is shown at 59 whereas a composite white pixel group for the right eye image is shown at 60. In this mode of operation, the green pixels 62 and 64 receive the same green image data and the green pixels 61 and 63 receive the same image data.

It is possible for the duplicated pixels in each composite group to be individually addressed so that the same data may be supplied to the appropriate pairs of pixels in the multiple view and single view modes merely by ensuring that the controller 11 duplicates the image data to the appropriate pixels. Alternatively, the appropriate interconnections may be provided within the addressing arrangement of the LCD 10.

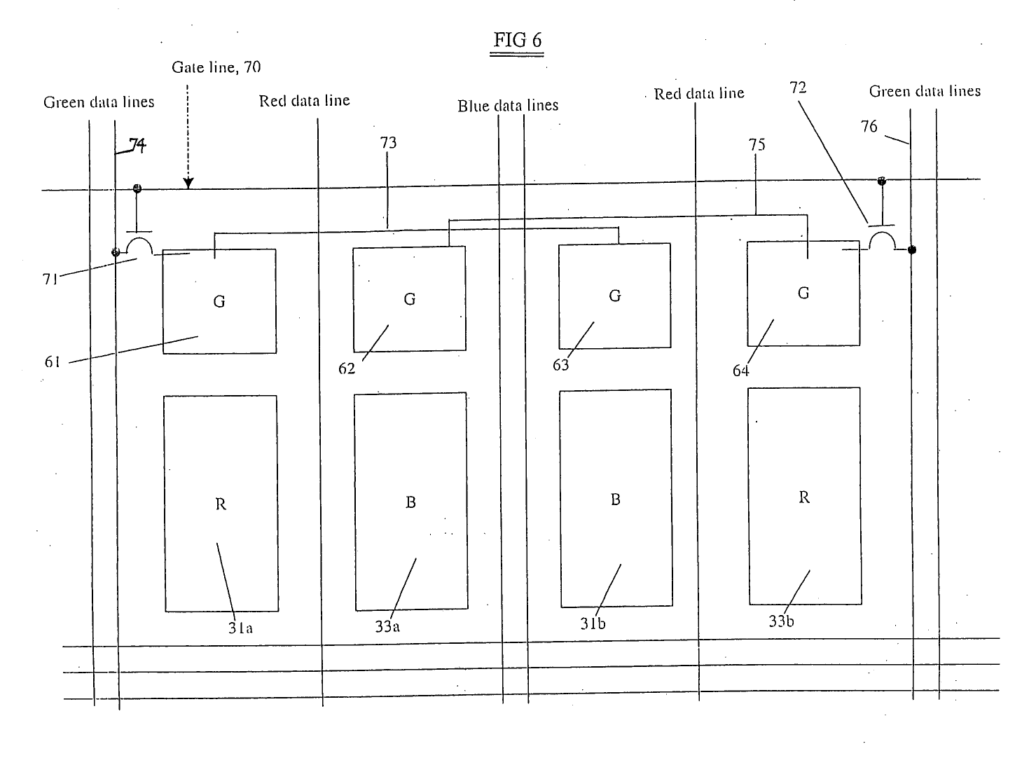

FIG. 6 illustrates an addressing arrangement in which the LCD 10 is intended for use only in the multiple view mode. The LCD 10 is intended for a dual view display in which each parallax optic cooperates with a pair of pixel columns to define the viewing regions 15 and 16. The addressing arrangement of the LCD is of the active matrix type with on-substrate thin film transistors connecting the pixels to the appropriate colour data lines in accordance with strobe signals on gate lines such as 70. For the sake of simplicity in FIG. 6, only the transistors 71 and 72 for the duplicated green pixels are shown. The green pixels 61 and 63 are permanently connected together by a conductor 73 so that, when the transistor 71 is enabled by a strobe pulse on the gate line 70, both of the pixels 61 and 63 are connected to the green data line 74. Similarly, the green pixels 62 and 64 are connected together by the conductor 75 and to the green data line 76 when the transistor 72 is enabled. Thus, the pixels 31a, 61, 63 and 31b form one composite pixel group whereas the pixels 33a, 62, 64 and 33b form another composite pixel group.

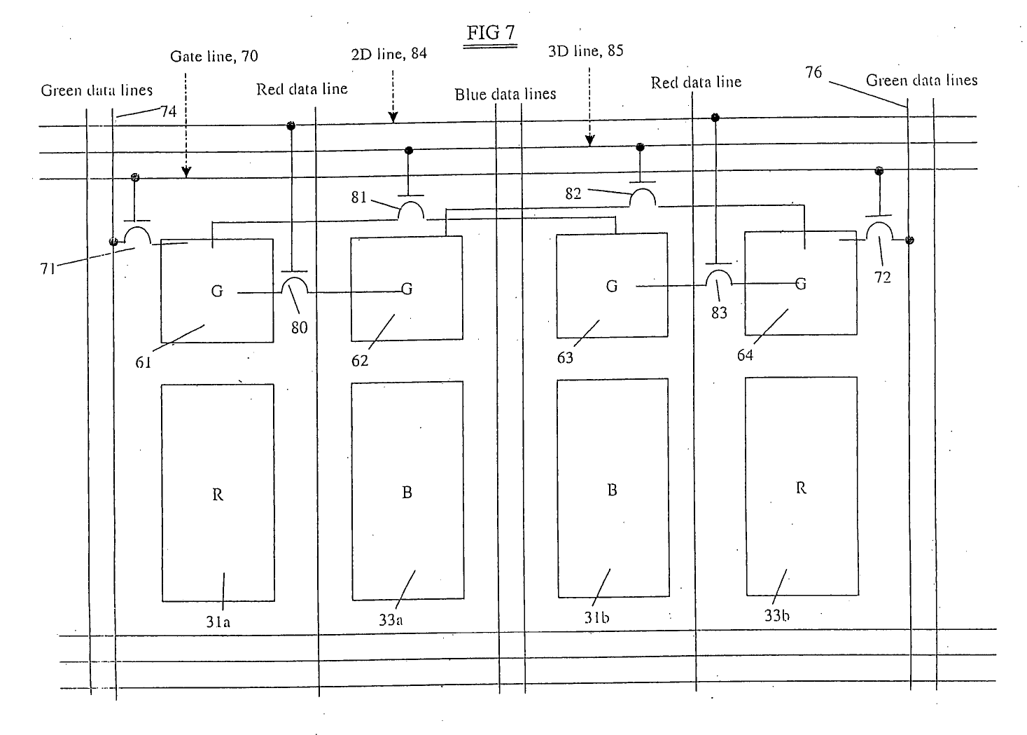

FIG. 7 illustrates an alternative arrangement which allows the LCD 10 to be switched between the single view mode of operation and the multiple view mode of operation. The arrangement of FIG. 7 differs from that of FIG. 6 in that the permanent connections 73 and 75 are replaced by a switching arrangement comprising thin film transistors 80 to 83, a 2D enable line 84 and a 3D enable line 85.

The enable lines 84 and 85 are controlled such that only one line at a time is enabled so as to select between 2D (single view) and 3D (multiple view) modes of operation. When the 3D enable line 85 is enabled, the transistors 81 and 82 are switched on whereas the transistors 80 and 83 are switched off. The green pixels 61 and 63 are connected together and the green pixels 62 and 64 are connected together so that the LCD operates in the same way as described hereinbefore for the embodiment of FIG. 6. Alternatively, when the 2D enable line 84 is enabled, the transistors 81 and 82 are switched off whereas the transistors 80 and 83 are switched on. The pixels 61 and 62 are connected together and the pixels 63 and 64 are connected together. Thus, in this mode of operation, the pixels 31a, 61, 62 and 33a form one composite group whereas the pixels 31b, 63, 64 and 33b form another composite pixel group.

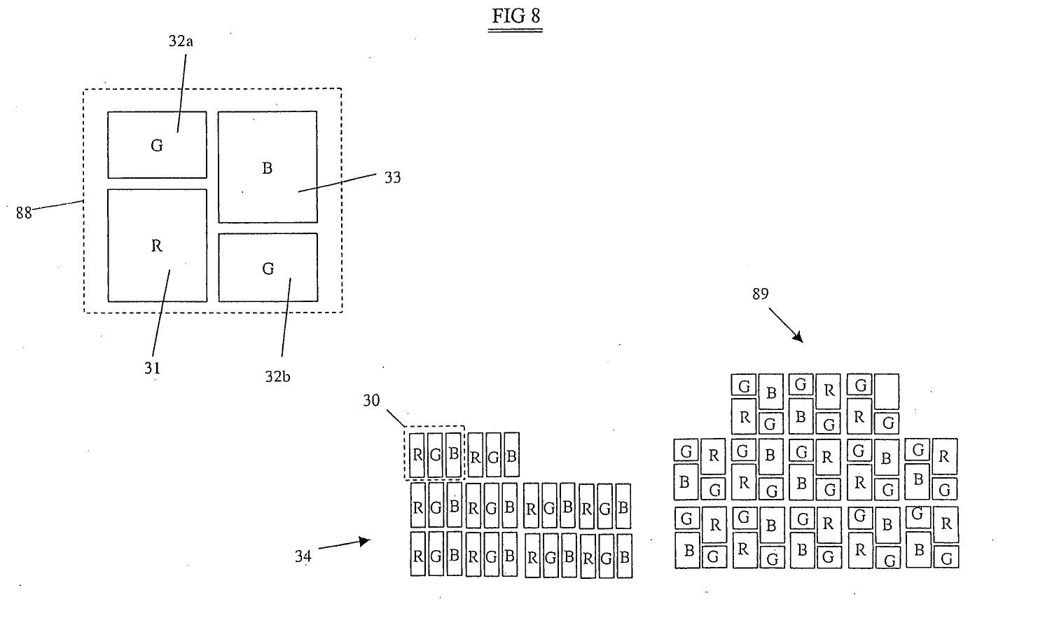

FIG. 8 illustrates another pixel arrangement in which each 2D or single view composite pixel group 88 differs from the group 40 shown in FIG. 4 in that the positions of the pixels 32b and 33 are exchanged. The row and column arrangement of the pixel groups is illustrated at 89.

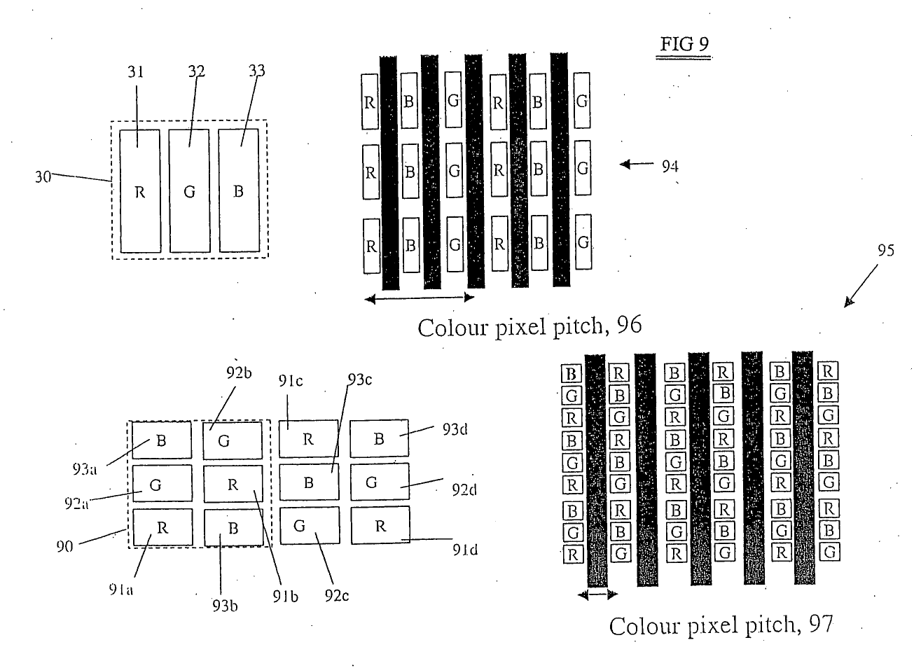

FIG. 9 illustrates another composite pixel arrangement 90 (for the single view mode of operation), comprising triplets of pixels in two columns. The composite group 90 comprises two red pixels 91a and 91b, two green pixels 92a and 92b, and two blue pixels 93a and 93b. The next group of red pixels 91c, 91d, green pixels 92c, 92d and blue pixels 93c, 93d are also shown.

In the single view or 2D mode of operation, the pixels 91a, 92a, 93a, 91c, 92c and 93c are connected to the pixels 91b, 92b, 93b, 91d, 92d and 93d, respectively, to form the composite groups such as 90. In the multiple view or 3D mode of operation, the pixels 91a, 92a, 93a, 91b, 92b and 93b are connected to the pixels 91c, 92c, 93c, 91d, 92d and 93d, respectively so that the pixel triplets in alternate rows form the composite pixel groups in this mode of operation.

The appearances of the display for one eye of a viewer are shown for the known arrangement at 94 and for the pixel groups 90 at 95. For the known arrangement, the effective colour pixel pitch 96 is equal to twice the composite white pixel group pitch whereas, for the groups 90, the colour pixel pitch 97 is equal to one group pitch and so is half of that for the known arrangement. The colour visibility is therefore reduced and is the same as the barrier visibility for the embodiment illustrated in FIG. 9. The view angle separation is increased as described for the previous embodiments.

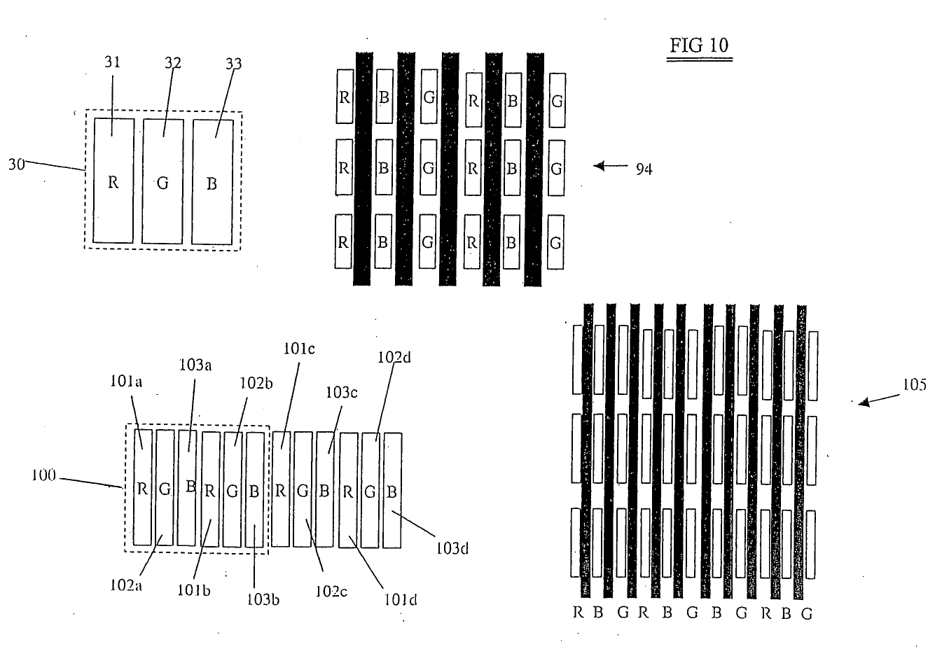

FIG. 10 illustrates another pixel pattern forming a composite white pixel group 100 in the single view (2D) mode. The composite group 100 comprises two groups of red, green and blue pixels 101a-103a, 101b-103b. Each pixel extends throughout the height of the pixel row of the LCD 10. The horizontally adjacent composite group also comprises two horizontally adjacent horizontal triplets of red, green and blue pixels 101c-103c, 101d-103d.

In the single view or 2D mode of operation, the pixels 101a, 102a, 103a, 101c, 102c, 103c are connected to and receive the same image data as the pixels 101b, 102b, 103b, 101d, 102d, 103d, respectively. In the multiple view or 3D mode of operation, the pixels 101a, 102a, 103a, 101b, 102b, 103b are connected to the pixels 101c, 102c, 103c, 101d, 102d, 103d, respectively. Thus, in the multiple view or 3D mode, the pixels 101a, 103a, 102b, 101c, 103c and 102d form a composite white pixel group.

The embodiment shown in FIG. 10 effectively provides a reduced pixel pitch compared with the known arrangement 30 so that a reduced view angle separation may be obtained. Thus, an increased viewing distance may be obtained for a given separation between the pixels and the parallax optic. Also, as shown at 105 in FIG. 10, the spatial frequency of the parallax barrier is substantially higher than for the known arrangement shown at 94. Barrier visibility and colour visibility are substantially reduced.

1. A multiple view display for displaying N views, where N is an integer greater than one, comprising: a display device comprising a plurality of composite pixel groups, each of which comprises pixels of at least three different colours with at least two of said pixels of a same colour; a parallax generating device cooperating with said display device to define a plurality of viewing regions; and means for supplying said at least two pixels of said same colour of each said group with a same image data.

2. A display as claimed in claim 1, in which said at least three different colours comprise three different colours.

3. A display as claimed in claim 2, in which said three different colours comprise red, green and blue.

4. A display as claimed in claim 1, in which said pixels are arranged as sets of N columns with each said set cooperating with a respective parallax element of said parallax device.

5. A display as claimed in claim 4, in which each said group comprises four said pixels and said at least two pixels of said same colour comprise two said pixels.

6. A display as claimed in claim 5, in which said groups are arranged as rows with said two pixels of said same colour being said same colour in each said row.

7. A display as claimed in claim 6, in which said two pixels of said same colour are said same colour in all of said rows.

8. A display as claimed in claim 5, in which said pixels of each said group are arranged as two pairs of different coloured said pixels in a pair of said columns separated by (N−1) of said columns.

9. A display as claimed in claim 5, in which said two pixels of said same colour have a smaller area than others of said pixels of each said group.

10. A display as claimed in claim 4, in which said three different colours comprise red, green and blue and in which each said group of said pixels comprises a pair of triplets of said red, green and blue pixels with said triplets in a pair of said columns separated by (N−1) of said columns.

11. A display as claimed in claim 4, in which said three different colours comprise red, green and blue and in which each said group of said pixels comprises a pair of triplets of said red, green and blue pixels arranged in a row with adjacent pairs of said pixels of each said group being separated by (N−1) of said columns.

12. A display as claimed in claim 1, in which said supplying means comprises a controller for supplying image data including said same image data to said display device.

13. A display as claimed in claim 1, in which said supplying means comprises a respective permanent connection between said at least two pixels of said same colour of each said group.

14. A display as claimed in claim 4, in which said supplying means comprises a switching arrangement for switching between a multiple view mode of operation, in which said at least two pixels of said same colour of each said group are connected together, and a one view mode of operation, in which each of said at least two pixels of said same colour of each said group is connected to another of said pixels of said same colour of a different one of said groups in an adjacent one of said columns.

15. A display as claimed in claim 1, in which said pixels of each said group have areas such that each said group is colour-balanced to white when each said pixel is at a maximum intensity.

16. A display as claimed in claim 1, in which said views are stereoscopically related.

17. A display as claimed in claim 1, in which said views are unrelated to each other.

18. A display as claimed in claim 1, in which N is equal to two.

19. A display as claimed in claim 1, in which said display device is a liquid crystal device.

20. A display as claimed in claim 1, in which said parallax device is a parallax barrier.
